(19) United States
(12) Patent Application Publication
(10) Pub. No.: US 2026/0272133 A1
(43) Pub. Date: Sep. 17, 2026

(54) PHONE CASE WITH HIDDEN STAND

(71) Applicant: CHRISTOPHE JAKOBUCO, Guangzhou (CN)

(72) Inventor: CHRISTOPHE JAKOBUCO, Guangzhou (CN)

(21) Appl. No.: 19/665,589

(22) Filed: May 1, 2026

(30) Foreign Application Priority Data
Feb. 3, 2026 (CN) 202620153582.5

(51) Int. Cl. A45C 11/00; H04M 1/04

(52) U.S. Cl. CPC A45C 11/002; H04M 1/04; A45C 2200/15; H04M 2250/52

(57) ABSTRACT

A phone case with a hidden stand is provided, and relates to the technical field of phone cases. The phone case includes a main body. The main body includes a bottom plate and a rim. The rim is fixedly arranged around a front surface of the bottom plate. A magnetic attraction ring is embedded into a back surface of the bottom plate. A stand assembly is arranged on the back surface of the bottom plate. The stand assembly covers the magnetic attraction ring. A magnetic attraction slot is formed in the stand assembly. The stand assembly includes a connecting portion and stand wings. The connecting portion is fixedly arranged on the back surface of the bottom plate. The stand wings capable of rotating around a connection position are arranged on two sides of the connecting portion.

### TECHNICAL FIELD

The present disclosure relates to the technical field of phone cases, and in particular, to a phone case with a hidden stand.

### BACKGROUND

With the increasing powerful functions, smart phones have become core devices that integrate audio and video entertainment and mobile office. Users' demands for mobile phone accessories have evolved from a single protective function to multi-functional integration and convenient experience. A phone case, as a most widely used accessory, can provide basic anti-drop and anti-scratch protection, and is often endowed with extended functions such as a stand, magnetic charging, and in-vehicle attraction. However, in the existing technology, regarding a phone case with a stand, its supporting structure (such as a ring buckle and a folding plate) usually protrudes out of a surface of a case body in a stored state. This impairs the gripping comfort and the portability. Regarding a phone case supporting a magnetic attraction function, its metal sheet or magnetic ring is usually directly exposed. This not only affects the appearance, but also causes physical or functional conflicts when the phone case is integrated with a stand functions. As a result, the attractive appearance and the stand function cannot be balanced.

### SUMMARY

For the shortcomings in the existing technology, the present disclosure aims at providing a phone case with a hidden stand, which can solve the problem that a mobile phone stand usually protrudes out of a surface of a case body in a stored state, which impairs the gripping comfort and the portability and the problem that a physical or functional conflict will occur during integration with a stand function, leading to a failure in balancing the attractive appearance and the stand function.

The objective of the present disclosure is achieved by the following technical solutions:

A phone case with a hidden stand is provided, including a main body. The main body includes a bottom plate and a rim. The rim is fixedly arranged around a front surface of the bottom plate. A magnetic attraction ring is embedded into a back surface of the bottom plate. A stand assembly is arranged on the back surface of the bottom plate. The stand assembly covers the magnetic attraction ring. A magnetic attraction slot is formed in the stand assembly. A position of the magnetic attraction slot matches the magnetic attraction ring. The stand assembly includes a connecting portion and stand wings. The connecting portion is fixedly arranged on the back surface of the bottom plate. The stand wings capable of rotating around a connection position are arranged on two sides of the connecting portion. A camera groove is formed in the front surface of the bottom plate. A bottom of the camera groove extends to the back surface of the bottom plate and protrudes outward. A plurality of camera lens holes are formed in the camera groove.

Preferably, the stand wings include a plurality of supporting portions and a plurality of rotating slots. The plurality of supporting portions are integrally formed. The rotating slots are formed between two adjacent supporting portions. The supporting portions rotate around adjacent rotating slots.

Preferably, the magnetic attraction ring is arranged in a center position of the back surface of the bottom plate, and the magnetic attraction slot is arranged on the stand wings.

Preferably, a plurality of snap-fit slots are formed in the back surface of the bottom plate in a manner of surrounding the camera groove. A raised protective member is arranged around an outer side of the camera groove. A plurality of snap-fit strips are fixedly arranged on an inner side of the protective member. A quantity and positions of the snap-fit strips match a quantity and positions of the snap-fit slots. The plurality of snap-fit strips are respectively snapped into the matching snap-fit slots.

Preferably, the snap-fit slots are uniformly distributed outside the camera groove.

Preferably, arc-shaped mounting slots are respectively formed in four corners on an inner side of the rim, and a plurality of buffer particles are fixedly arranged on four edges of the inner side of the rim.

Preferably, a sliding key slot is formed in a side wall of the rim. A side wall of the sliding key slot is an arc-shaped structure; and a sliding key hole is formed in a bottom of the sliding key slot.

Beneficial effects of the present disclosure are as follows:

According to the phone case with the hidden stand, the magnetic attraction ring is embedded into the back surface of the bottom plate. The stand assembly is arranged on the back surface of the bottom plate. The stand assembly covers the magnetic attraction ring. The magnetic attraction slot is formed in the stand assembly. The stand assembly includes the connecting portion and stand wings. The connecting portion is fixedly arranged on the back surface of the bottom plate. The stand wings capable of rotating around the connection position are arranged on the two sides of the connecting portion. The stand wings can be completely folded to abut against the back surface, so that the entire phone case remains flat without protrusions, facilitating daily gripping, pocket storage, or wireless charging, and has a concise and aesthetic appearance. In addition, whether the stand is in a folded or unfolded state, the embedded magnetic attraction ring can be firmly attracted to an external magnetic attraction accessory (such as an in-vehicle holder or a charger) normally, thus achieving a balance between a supporting function and a magnetic attraction function without interference.

### BRIEF DESCRIPTION OF THE DRAWINGS

FIG. 1 is a schematic diagram of a structure of a front surface of the present disclosure;

FIG. 2 is a schematic diagram of a structure of a back surface of the present disclosure;

FIG. 3 is a schematic diagram of a structure of stand wings being unfolded according to the present disclosure; and

FIG. 4 is a schematic diagram of a structure of a protective member in the present disclosure.

In the drawings: 1: main body; 101: bottom plate; 102: rim; 2: magnetic attraction ring; 3: stand assembly; 4: magnetic attraction slot; 5: connecting portion; 6: stand wing; 601: supporting portion; 602: rotating slot; 7: camera groove; 8: camera lens hole; 9: snap-fit slot; 10: protective member; 11: snap-fit strip; 12: mounting slot; 13: buffer particle; 14: sliding key slot; and 15: sliding key hole.

### DETAILED DESCRIPTION OF THE EMBODIMENTS

In order to make the technical problems to be solved, technical solutions, and beneficial effects of the present disclosure clearer, the following is a further detailed explanation of the present disclosure in conjunction with the accompanying drawings and embodiments.

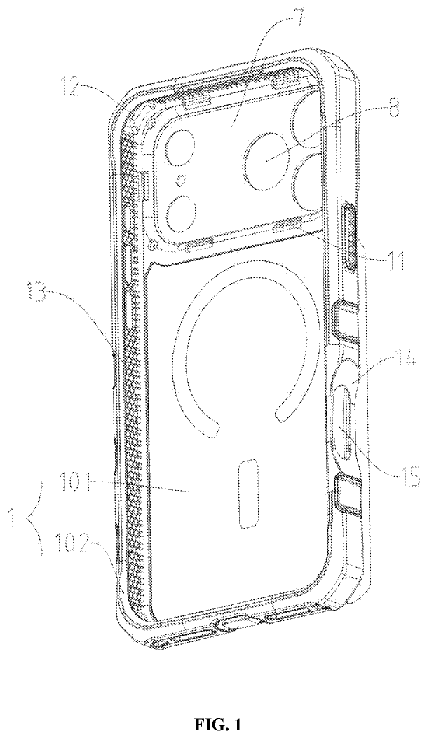

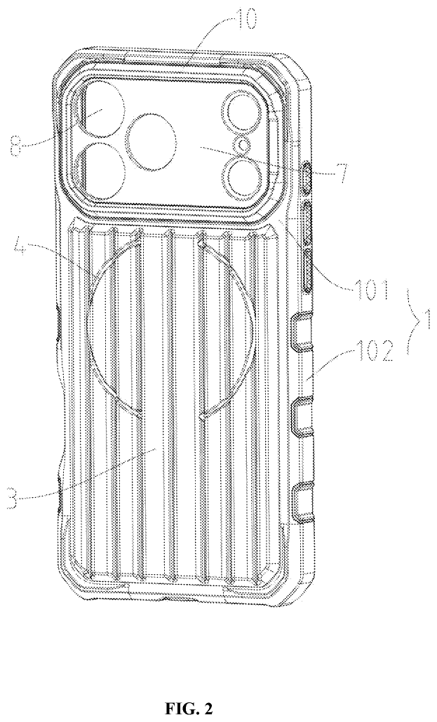

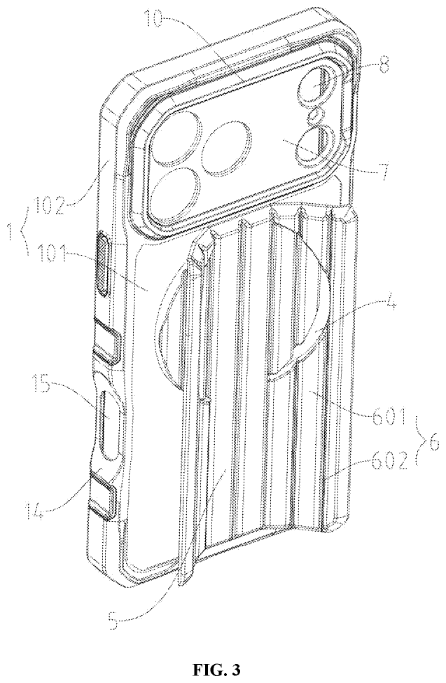

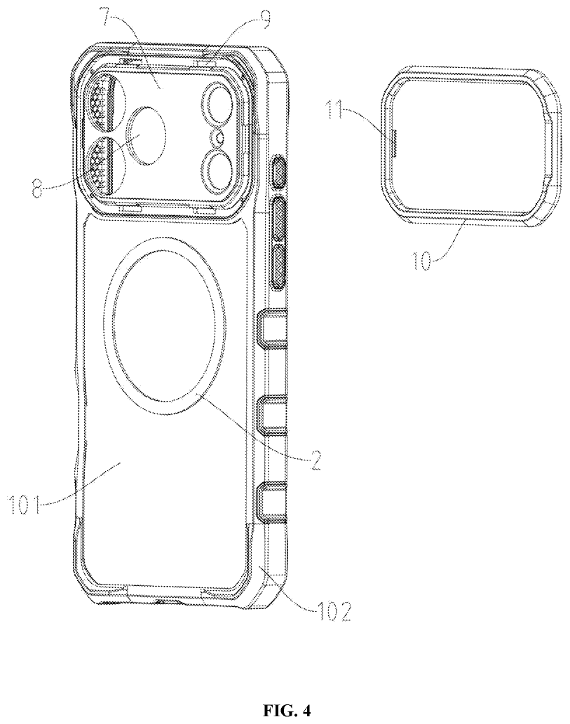

According to the embodiments provided in the present disclosure, as shown in FIG. 1 to FIG. 4, a phone case with a hidden stand includes a main body 1. The main body 1 includes a bottom plate 101 and a rim 102. The rim 102 is fixedly arranged around a front surface of the bottom plate 101. A magnetic attraction ring 2 is embedded into a back surface of the bottom plate 101. A stand assembly 3 is arranged on the back surface of the bottom plate 101. The stand assembly 3 covers the magnetic attraction ring 2. A magnetic attraction slot 4 is formed in the stand assembly 3. A position of the magnetic attraction slot 4 matches the magnetic attraction ring 2. The stand assembly 3 includes a connecting portion 5 and stand wings 6. The connecting portion 5 is fixedly arranged on the back surface of the bottom plate 101. The stand wings 6 capable of rotating around a connection position are arranged on two sides of the connecting portion 5. A camera groove 7 is formed in the front surface of the bottom plate 101. A bottom of the camera groove 7 extends to the back surface of the bottom plate 101 and protrudes outward. A plurality of camera lens holes 8 are formed in the camera groove 7.

During use, a user puts a mobile phone into the main body 1. The rim 102 surrounds and wraps around side surfaces of the mobile phone, to provide basic edge anti-drop and anti-scratch protection. A camera module of the mobile phone is aligned with and embedded into the camera groove 7 on the front surface of the bottom plate 101, and the lens holes 8 ensure that a camera, a flash light, and the like are unobstructed. In this case, the stand assembly 3 located on the back surface of the bottom plate 101 is in a folded state and flatly abuts against the back surface, so that the entire phone case remains flat to facilitate pocket storage or wireless charging. When the user needs to support the mobile phone on a desktop, the user can move the stand wings 6 located on the back surface of the bottom plate 101. Since the stand wings 6 are fixed by the connecting portion 5 and is designed to rotate around the connection position, the user can fold the stand wings outward in an angle (usually 60° to 80°) from the abutting state, so that the mobile phone can stand steadily on the desktop from a horizontal or vertical perspective. To cause the mobile phone to be attracted to a magnetic attraction in-vehicle holder, a magnetic attraction charger, or other magnetic attraction accessories, the user needs to place the back surface of the phone case close to the accessory. The magnetic attraction ring 2 embedded into the back surface of the bottom plate 101 will generate a strong magnetic attraction force with a magnet of the accessory. Since the stand assembly 3 covering the magnetic attraction ring 2 is provided with the magnetic attraction slot 4, and its position matches the magnetic attraction ring 2, the magnetic force can pass through this slot almost without loss, thus achieving firm attraction. In addition, in a specific scenario, the user can use the two functions at the same time. For example, the phone case with the stand wings 6 unfolded can be attracted to a refrigerator sticker or metal stand with a magnetic attraction function through the magnetic attraction ring 2 on the back surface, thus achieving a more flexible placement angle.

Preferably, the stand wings 6 include a plurality of supporting portions 601 and a plurality of rotating slots 602. The plurality of supporting portions 601 are integrally formed. The rotating slots 602 are formed between two adjacent supporting portions 601. The supporting portions 601 rotate around adjacent rotating slots 602. The stand wings 6 are hinged structures that are folded in multiple angles sectionally. This design achieves a core effect of greatly enhancing the angle adaptability and supporting stability of the stand. A user can bend the supporting portions 601 in the rotating slots 602 at different positions to form different supporting angles and forms based on different viewing needs (such as horizontal screen viewing, vertical screen browsing, and video call). The plurality of supporting portions 601 provide a wider supporting base and a plurality of contact points with a desk, so that the mobile phone is more stable in different angles and is less prone to tipping over.

Preferably, the magnetic attraction ring 2 is arranged in a center position of the back surface of the bottom plate 101, and the magnetic attraction slot 4 is arranged on the stand wings 6. The magnetic attraction ring 2 is arranged in the center position of the back surface of the bottom plate 101, which follows a common center-of-gravity position of the mobile phone, so that the mobile phone is more balanced and stable when suspended by a magnetic attraction accessory. The magnetic attraction slot 4 is arranged on the stand wings 6, so that the magnetic attraction function can operate normally regardless of whether the stand wings 6 are in an unfolded state or a folded state, and the use is convenient.

Preferably, a plurality of snap-fit slots 9 are formed in the back surface of the bottom plate 101 in a manner of surrounding the camera groove 7. A raised protective member 10 is arranged around an outer side of the camera groove 7. A plurality of snap-fit strips 11 are fixedly arranged on an inner side of the protective member 10. A quantity and positions of the snap-fit strips 11 match a quantity and positions of the snap-fit slots 9. The plurality of snap-fit strips 11 are respectively snapped into the matching snap-fit slots 9. The raised protective member 10 can avoid direct contact between camera lenses and a desktop when the mobile phone is placed horizontally, thus effectively preventing the lenses from being worn or scratched. In addition, by the use of a snap-fit structure, the protective member 10 can be replaced according to user preferences (such as a color and a material), or is individually replaced after damage. This enhances the durability of the product without replacing the entire phone case.

Preferably, the snap-in slots 9 are uniformly distributed outside the camera groove 7 to ensure that the protective member 10 is uniformly stressed during mounting, firmly connected, and not easily loosened. Uniformly distributed snap-fit points jointly share forces on the protective member 10 in all directions (such as an impact force of accidental collision and a pulling force of frequent removal), to prevent a snap-in point from being broken or failing due to local stress concentration, thus significantly enhancing the durability of an assembled structure of the protective member 10.

Preferably, arc-shaped mounting slots 12 are respectively formed in four corners on an inner side of the rim 102, and a plurality of buffer particles 13 are fixedly arranged on four edges of the inner side of the rim 102. When a user places a mobile phone, a user can be guided, four rounded corners of the mobile phone can be first aligned, and the mobile phone can fall within the mounting slots 12, thereby achieving fast and accurate alignment and preventing the phone case from being mounted obliquely. After the mobile phone is placed, the buffer particles 13 form elastic contact with side surfaces of the mobile phone. This not only absorbs and buffers a lateral impact force on the mobile phone in daily use, but also prevents the mobile phone from shaking, producing abnormal noise, or being worn inside the phone case, and can increase gripping friction.

Preferably, a sliding key slot 14 is formed in a side wall of the rim 102. A side wall of the sliding key slot 14 is an arc-shaped structure. A sliding key hole 15 is formed in a bottom of the sliding key slot 14. The side wall of the sliding key slot 14 is the arc-shaped structure, so that it is convenient for a finger to enter. This design enhances the convenience of human-machine interaction.

According to the phone case with the hidden stand, the magnetic attraction ring 2 is embedded into the back surface of the bottom plate 101. The stand assembly 3 is arranged on the back surface of the bottom plate 101. The stand assembly 3 covers the magnetic attraction ring 2. The magnetic attraction slot 4 is formed in the stand assembly 3. The stand assembly 3 includes the connecting portion 5 and stand wings 6. The connecting portion 5 is fixedly arranged on the back surface of the bottom plate 101. The stand wings 6 capable of rotating around the connection position are arranged on the two sides of the connecting portion 5. The stand wings 6 can be completely folded to abut against the back surface, so that the entire phone case remains flat without protrusions, facilitating daily gripping, pocket storage, or wireless charging, and has a concise and aesthetic appearance. In addition, whether the stand is in a folded or unfolded state, the embedded magnetic attraction ring 2 can be firmly attracted to an external magnetic attraction accessory (such as an in-vehicle holder or a charger) normally, thus achieving a balance between a supporting function and a magnetic attraction function without interference.

The above describes the preferred embodiments of the present disclosure and is not intended to limit the present disclosure. Any modification, equivalent replacement, and improvement made within the spirit and scope of the present disclosure shall fall within the protection scope of the present disclosure.

What is claimed is:

1. A phone case with a hidden stand, comprising a main body (1), wherein the main body (1) comprises a bottom plate (101) and a rim (102); the rim (102) is fixedly arranged around a front surface of the bottom plate (101); a magnetic attraction ring (2) is embedded into a back surface of the bottom plate (101); a stand assembly (3) is arranged on the back surface of the bottom plate (101); the stand assembly (3) covers the magnetic attraction ring (2); a magnetic attraction slot (4) is formed in the stand assembly (3); a position of the magnetic attraction slot (4) matches the magnetic attraction ring (2); the stand assembly (3) comprises a connecting portion (5) and stand wings (6); the connecting portion (5) is fixedly arranged on the back surface of the bottom plate (101); the stand wings (6) capable of rotating around a connection position are arranged on two sides of the connecting portion (5); a camera groove (7) is formed in the front surface of the bottom plate (101); a bottom of the camera groove (7) extends to the back surface of the bottom plate (101) and protrudes outward; and a plurality of camera lens holes (8) are formed in the camera groove (7).

2. The phone case with the hidden stand according to claim 1, wherein the stand wings (6) comprise a plurality of supporting portions (601) and a plurality of rotating slots (602); the plurality of supporting portions (601) are integrally formed; the rotating slots (602) are formed between two adjacent supporting portions (601); and the supporting portions (601) rotate around adjacent rotating slots (602).

3. The phone case with the hidden stand according to claim 1, wherein the magnetic attraction ring (2) is arranged in a center position of the back surface of the bottom plate (101), and the magnetic attraction slot (4) is arranged on the stand wings (6).

4. The phone case with the hidden stand according to claim 1, wherein a plurality of snap-fit slots (9) are formed in the back surface of the bottom plate (101) in a manner of surrounding the camera groove (7); a raised protective member (10) is arranged around an outer side of the camera groove (7); a plurality of snap-fit strips (11) are fixedly arranged on an inner side of the protective member (10); a quantity and positions of the snap-fit strips (11) match a quantity and positions of the snap-fit slots (9); and the plurality of snap-fit strips (11) are respectively snapped into the matching snap-fit slots (9).

5. The phone case with the hidden stand according to claim 4, wherein the snap-fit slots (9) are uniformly distributed outside the camera groove (7).

6. The phone case with the hidden stand according to claim 1, wherein arc-shaped mounting slots (12) are respectively formed in four corners on an inner side of the rim (102), and a plurality of buffer particles (13) are fixedly arranged on four edges of the inner side of the rim (102).

7. The phone case with the hidden stand according to claim 1, wherein a sliding key slot (14) is formed in a side wall of the rim (102); a side wall of the sliding key slot (14) is an arc-shaped structure; and a sliding key hole (15) is formed in a bottom of the sliding key slot (14).
